(19) United States
(12) Patent Application Publication
(10) Pub. No.: US 2026/0139799 A1
(43) Pub. Date: May 21, 2026

(54) Storage and Dispensing System for Cryogenic Fluids

(71) Applicant: Chart Inc., Ball Ground, GA (US)

(72) Inventors: Erik Gustafson, Woodstock, GA (US); Kevin Rogers, Canton, GA (US); Philip Scales, Cumming, GA (US)

(21) Appl. No.: 19/396,843

(22) Filed: Nov. 21, 2025

Related U.S. Application Data
(60) Provisional application No. 63/723,454, filed on Nov. 21, 2024.

(51) Int. Cl. F17C 7/04; F17C 13/02; F17C 13/04

(52) U.S. Cl. CPC F17C 7/04; F17C 13/021; F17C 13/04; F17C 2221/033; F17C 2227/0107; F17C 2227/0157; F17C 2227/046; F17C 2250/0417; F17C 2250/043; F17C 2250/0626; F17C 2250/072; F17C 2270/0168

(57) ABSTRACT

A system and method for active control of withdrawing and dispensing cryogenic fluid from a storage system including multiple tanks.

### CLAIM OF PRIORITY

This application claims the benefit of U.S. Provisional Application No. 63/723,454, filed Nov. 21, 2024, the contents of which are hereby incorporated by reference.

### FIELD OF DISCLOSURE

The present disclosure relates generally to systems and methods for withdrawing and dispensing cryogenic fluid from storage tanks and, more particularly, to systems and methods for active control of withdrawing and dispensing cryogenic fluid from a storage system including multiple tanks.

### BACKGROUND

Cryogenic liquids are stored in, and dispensed from, insulated tanks in numerous applications. For example, liquid natural gas (LNG) and liquid hydrogen (LH2) are each used as fuels by a number of commercial or industrial vehicles. The vehicles may be propelled by an internal combustion engine or by a fuel cell. The LNG or LH2 fuel is stored in its cryogenic liquid state for maximum density, and the end-use device requires the fluid to be gaseous and near-ambient temperature. Usually vehicles have a minimum allowable fuel delivery pressure that may be in the range of 50-100 psig as an example.

To maximize the amount of fuel on board the vehicle, it is usually desirable to store the fuel in several tanks on the vehicle. In the case of heavy trucks, tanks are usually mounted on each side of the vehicle on the frame rail or in a rack behind the cab of the truck. In the case of buses, multiple tanks may be mounted under the floor or on the roof of the bus.

Even withdrawal of cryogenic fluid from the tanks of a multi-tank cryogenic fuel system is desirable. Often the tanks on one vehicle are designed to be refilled simultaneously, and the fill connections of each tank may be manifolded together. If one tank empties significantly sooner than the other tanks, it will begin to warm up while the other tanks remain cold due to the remaining cryogenic fuel. When refilling multiple tanks simultaneously, a warm tank will tend to not fill with cryogenic liquid due to its elevated temperature, and thus pressure. Therefore, it is desirable for all the tanks in a multi-tank system to empty at the same rate to maintain relatively equal temperatures and ensure proper refilling of all tanks.

An example of a basic cryogenic delivery and storage system is provided in U.S. Pat. No. 5,421,161 to Gustafson (hereinafter the Gustafson '161 patent) and includes a cryogenic vessel, a delivery line extending from the cryogenic vessel to the use device such as engine, a vaporizer on the delivery line and an economizer circuit. Within the cryogenic liquid vessel are a liquid space and a gas, or vapor, space. The delivery line includes a liquid line that is in fluid communication with the cryogenic vessel liquid space. An economizer circuit including a vapor line is in fluid communication with both the cryogenic vessel vapor space and the liquid line. Downstream of this joint between the liquid line and the vapor line, the delivery line may contain liquid, gas, or a combination of liquid and gas. Because the use device uses natural gas in a gaseous state, a vaporizer may be located upstream of the use device.

An overflow tank and a special main tank are used by the cryogenic storage and dispensing system of U.S. Pat. No. 5,421,162 to Gustafson et al. (hereinafter the Gustafson et al. '162 patent) and are designed to remain hydraulically full to maintain sufficient pressure to the engine no matter the liquid's saturation pressure. However, the special fuel tanks add extra cost and complexity to the system. Also, once the tanks are in use and saturated to pressure, there is no active control.

French Patent Application Publ. No. 2,706,822 adds heat to the fluid inside the tank via a pressure building line re-entering the tank and a control valve. The '822 patent does not describe a system for multiple tanks. Similar to the French '822 published patent application, U.S. Pat. No. 11,371,654 to Poag et al. (hereinafter the Poag '654 patent) adds heat to the fluid inside the tank without a control system.

Another prior art cryogenic fluid storage and delivery system is disclosed in U.S. Pat. No. 9,903,534 to Gustafson et al. (hereinafter the Gustafson '534 patent). The system, illustrated in FIG. 1, reproduced from the Gustafson '534 patent and described in greater detail below, includes an active pressure building circuit in addition to the economizer circuit presented in the Gustafson '161 patent. The additional active pressure building circuit includes a compressor or pump situated on a parallel path downstream of the vaporizer to actively force natural gas vapor hack into the vehicle fuel tank, adding heat to the tank at a rate that exceeds that which could be accomplished by passive systems. Compressor operation is controlled by a control system that monitors the system pressure, turns the compressor on when system pressure is low and turns the compressor off when the system pressure reaches a predefined point. Once the liquid is saturated, the cryogenic delivery system functions as the system described in the Gustafson '161 patent. According to the Gustafson '534 patent, a further embodiment of the delivery system may apply the active pressure building circuit to multiple cryogenic liquid storage tanks configured in parallel.

When used in multiple tank systems, the cryogenic fluid storage tanks of the above systems are typically “teed” together and use symmetric piping to form a multiple tank fuel storage system with the hope of achieving a balanced withdrawal of cryogenic fluid from the multiple tanks. However, due to small differences in piping dimensions or tank elevations or tank insulation performances or tank sizes, one tank system may withdraw slightly faster than the other(s).

### SUMMARY

In a first aspect, a cryogenic fluid delivery system includes a first storage tank (22a) configured to contain a first supply of cryogenic liquid (26a). The first storage tank (22a) includes a first head space (36a) configured to contain a first vapor above the first supply of cryogenic liquid (26a) stored in the first storage tank (22a). A first liquid withdrawal line (28a) is configured to communicate with the first supply of cryogenic liquid (26a). A vaporizer (32) has an inlet in communication with the first liquid withdrawal line (28a) and an outlet in communication with a vapor delivery line (46). A pressure building circuit is in communication with the vapor delivery line (46) and the first head space (36a) of the first storage tank (22a) and includes a flow inducing device (52). A first pressure control valve (56a) is in communication with an outlet of the flow inducing device (52) and the first head space (36a). A second storage tank (22b) is configured to contain a second supply of cryogenic liquid (26b) and includes a second head space (36b) configured to contain a second vapor above the second supply of cryogenic liquid (26b) stored in the second storage tank (22b). A second liquid withdrawal line (28b) has an inlet configured to communicate with the second supply of cryogenic liquid (26b). The second liquid withdrawal line (28b) has an outlet in fluid communication with the vapor delivery line (46). A second pressure control valve (56b) is in communication with the outlet of the flow inducing device (52) and the second head space (36b). A first fill level measurement device (20a) is configured to measure a first fill level in the first storage tank (22a) and a second fill level measurement device (20b) is configured to measure a second fill level in the second storage tank (22b). A first pressure sensor is configured to detect a first pressure of the first head space (36a) and a second pressure sensor configured to detect a second pressure of the second head space (36b). A controller is configured to communicate with the first and second fill level measurement devices, the first and second pressure sensors, the flow inducing device (52), the first pressure control valve (56a) and the second pressure control valve (56b).

In a second aspect, the disclosure provides a method of operating cryogenic fluid delivery system having a flow inducing device, a first storage tank (22a) containing a first supply of cryogenic liquid (26a) and a first head space (36a) containing a first vapor above the first supply of cryogenic liquid (26a) and a second storage tank (22b) containing a second supply of cryogenic liquid (26b) and a second head space (36b) containing a second vapor above the second supply of cryogenic liquid (26b) stored in the second storage tank (22b). The method includes the steps of: detecting a first pressure in the first storage tank (22a) and a second pressure in the second storage tank (22b); determining if either the first or the second pressure falls below a predetermined pressure threshold; measuring a first fill level in the first storage tank (22a) and a second fill level in the second storage tank (22b); calculating a fill level difference between the first and second fill levels; determining if the fill level difference exceeds a preset imbalance threshold; activating the flow inducing device (52) if either the first or the second pressure falls below the predetermined pressure threshold to: (i) pressurize the first storage tank (22a) if the first fill level is more than the second fill level and the fill level difference exceeds the preset imbalance threshold; or (ii) pressurize the second storage tank (22a) if the second fill level is more than the first fill level and the fill level difference exceeds the preset imbalance threshold; or (iii) pressurize both the first and second storage tanks if the fill level difference does not exceed the preset imbalance threshold.

In a third aspect, a cryogenic fluid delivery system includes a first storage tank (22a) configured to contain a first supply of cryogenic liquid (26a). The first storage tank (22a) includes a first head space (36a) configured to contain a first vapor above the first supply of cryogenic liquid (26a) stored in the first storage tank (22a). A first liquid withdrawal line (28a) communicates with the first supply of cryogenic liquid (26a). A vaporizer (32) has an inlet in communication with the first liquid withdrawal line (28a) and an outlet in communication with a vapor delivery line. A second storage tank (22b) is configured to contain a second supply of cryogenic liquid (26b) and includes a second head space (36b) configured to contain a second vapor above the second supply of cryogenic liquid (26b). A second liquid withdrawal line (28b) has an inlet configured to communicate with the second supply of cryogenic liquid (26b). The second liquid withdrawal line (28b) has an outlet in fluid communication with the vapor delivery line (46). A first fill level measurement device (20a) is configured to measure a first fill level in the first storage tank (22a) and a second fill level measurement device is (20b) configured to measure a second fill level in the second storage tank (22b). A first outlet control valve (75a) is in fluid communication with the first liquid withdrawal line (28a). A second outlet control valve (75b) is in fluid communication with the second liquid withdrawal line (28b). A controller is configured to communicate with the first and second fill level measurement devices, the first outlet control valve (75a) and the outlet control valve (75b).

In a fourth aspect, the disclosure provides a method of operating a cryogenic fluid delivery system having a first storage tank (22a) containing a first supply of cryogenic liquid (26a) and a first head space (36a) containing a first vapor above the first supply of cryogenic liquid (26a), a second storage tank (22b) containing a second supply of cryogenic liquid (26b) and a second head space (36b) containing a second vapor above the second supply of cryogenic liquid (26b) stored in the second storage tank (22b), a first liquid withdrawal line having a first outlet control valve (75a) in fluid communication with the first supply of cryogenic liquid and a second liquid withdrawal line having a second outlet control valve (75b) in fluid communication with the second supply of cryogenic liquid. The method includes the steps of: measuring a first fill level in the first storage tank (22a) and a second fill level in the second storage tank (22b); calculating a fill level difference between the first and second fill levels; determining if the fill level difference exceeds a preset imbalance threshold; adjusting the first outlet control valve and/or the second outlet control valve to: (i) increase a flow of cryogenic liquid out of the first storage tank (22a) if the first fill level is more than the second fill level and the fill level difference exceeds the preset imbalance threshold; or (ii) increase the flow of cryogenic liquid out of the second storage tank (22a) if the second fill level is more than the first fill level and the fill level difference exceeds the preset imbalance threshold.

In a fifth aspect, a cryogenic fluid delivery system includes a first storage tank (22a) including a first head space (36a) configured to contain a first vapor above the first supply of cryogenic liquid (26a) stored in the first storage tank (22a). A first liquid withdrawal line (209a) communicates with the first supply of cryogenic liquid (26a). A first vaporizer (210a) has a first primary heat transfer passage (212a) with an inlet in communication with the first liquid withdrawal line (209a) and an outlet. A first valve system (211a) has an inlet that receives vapor from the outlet of the first primary heat transfer passage (212a) of the first vaporizer (210a), a primary outlet in fluid communication with a vapor delivery line (216) and a pressure building outlet. A first heat exchanger (214a) is submerged in the first supply of cryogenic liquid (26a) in the first storage tank (22a) and has an inlet in fluid communication with the pressure building outlet of the first valve system and an outlet. The first vaporizer (210a) has a first secondary heat transfer passage (221a) configured to receive fluid from the outlet of the first heat exchanger (214a) and to direct warmed fluid to the vapor delivery line (216). A second storage tank (22b) contains a second supply of cryogenic liquid (26b) and includes a second head space (36b) configured to contain a second vapor above the second supply of cryogenic liquid (26b) stored in the second storage tank (22b). A second liquid withdrawal line (209b) communicates with the second supply of cryogenic liquid (26b). A second vaporizer (210b) has a second primary heat transfer passage (212b) with an inlet in communication with the second liquid withdrawal line (209b) and an outlet. A second valve system (211b) has an inlet configured to receive vapor from the outlet of the second primary heat transfer passage (212b) of the second vaporizer (210b), a primary outlet in fluid communication with the vapor delivery line (216) and a pressure building outlet. A second heat exchanger (214b) is submerged in the second supply of cryogenic liquid (26b) in the second storage tank (22b) and has an inlet in fluid communication with the pressure building outlet of the second valve system and an outlet. The secondary vaporizer (210b) has a second secondary heat transfer passage (221b) configured to receive fluid from the outlet of the second heat exchanger (214b) and to direct warmed fluid to the vapor delivery line (216). A first fill level measurement device (20a) measures a first fill level in the first storage tank (22a) and a second fill level measurement device (20b) measures a second fill level in the second storage tank (22b). A first pressure sensor detects a first pressure of the first head space (36a) and a second pressure sensor detects a second pressure of the second head space (36b). A controller (70) communicates with the first and second fill level measurement devices, the first and second pressure sensors and the first and second valve systems.

In a sixth aspect, the disclosure provides a method of operating a cryogenic fluid delivery system having a first storage tank (22a) containing a first supply of cryogenic liquid (26a) and a first head space (36a) containing a first vapor above the first supply of cryogenic liquid (26a), a second storage tank (22b) containing a second supply of cryogenic liquid (26b) and a second head space (36b) containing a second vapor above the second supply of cryogenic liquid (26b) stored in the second storage tank (22b), a first heat exchanger (214a) submerged in the first supply of cryogenic liquid, a second heat exchanger (214b) submerged in the second supply of cryogenic liquid, a first valve system which may be adjusted to direct cryogenic liquid from the first storage tank (22a) to the first heat exchanger (214a) and a second valve system which may be adjusted to direct cryogenic liquid from the second storage tank (22b) to the second heat exchanger (214b). The method includes the steps of: detecting a first pressure in the first storage tank (22a) and a second pressure in the second storage tank (22b); determining if either the first or the second pressure falls below a predetermined pressure threshold; measuring a first fill level in the first storage tank (22a) and a second fill level in the second storage tank (22b); calculating a fill level difference between the first and second fill levels; determining if the fill level difference exceeds a preset imbalance threshold; adjusting the first valve system and/or the second valve system if either the first or the second pressure falls below the predetermined pressure threshold to: (i) pressurize the first storage tank (22a) if the first fill level is more than the second fill level and the fill level difference exceeds the preset imbalance threshold; or (ii) pressurize the second storage tank (22a) if the second fill level is more than the first fill level and the fill level difference exceeds the preset imbalance threshold; or (iii) pressurize both the first and second storage tanks if the fill level difference does not exceed the preset imbalance threshold.

Further aspects and embodiments are provided in the foregoing drawings, detailed description and claims.

### BRIEF DESCRIPTION OF DRAWINGS

The following drawings are provided to illustrate certain embodiments described herein. The drawings are merely illustrative and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1 is a schematic view of a prior art multiple tank cryogenic fluid storage and delivery system.

FIG. 2 is a schematic view of a multiple tank cryogenic fluid storage and delivery system in a first embodiment of the cryogenic fluid storage and delivery system of the present disclosure.

FIG. 3 is a flow chart illustrating a method for operating the cryogenic fluid storage and delivery system of FIG. 2.

FIG. 4 is a schematic view of a multiple tank cryogenic fluid storage and delivery system in a second embodiment of the cryogenic fluid storage and delivery system of the present disclosure.

FIG. 5 is a flow chart illustrating a method for operating the cryogenic fluid storage and delivery system of FIG. 4.

FIG. 6 is a schematic view of a multiple tank cryogenic fluid storage and delivery system in a third embodiment of the cryogenic fluid storage and delivery system of the present disclosure.

### DETAILED DESCRIPTION

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

While the embodiments of the system of the disclosure described below reference LNG and LH2 as the cryogenic fluid in a multiple tank system mounted to a vehicle, it is to be understood that the invention may alternatively be used to deliver or dispense other types of cryogenic fluids in alternative applications.

As examples only, the technology of the disclosure can be used to complement systems described in the Gustafson '161, Gustafson '534, French '822, and/or Poag '654 patents, the contents of each of which are hereby incorporated by reference.

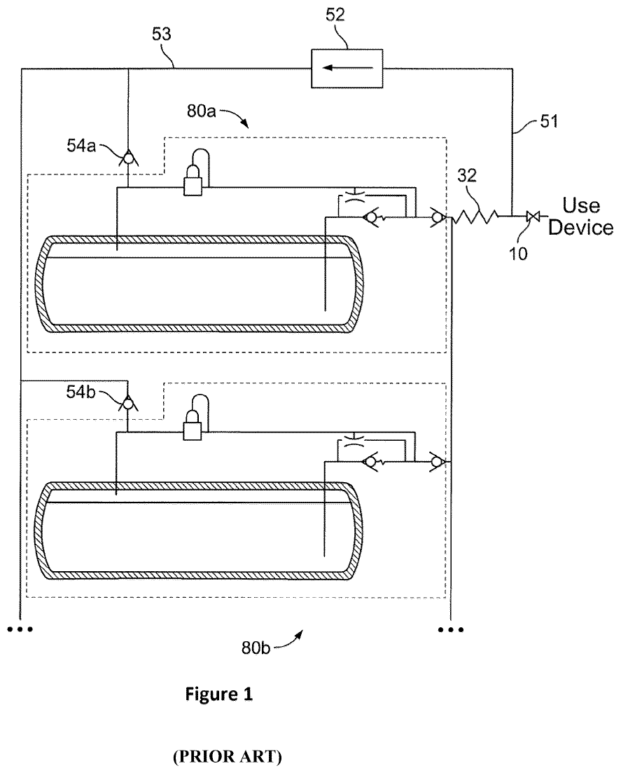

FIG. 1 depicts an embodiment of the fuel delivery system of the Gustafson '534 patent, a brief description of which will now be presented. Tank system 80a and tank system 80b are each further detailed in the Gustafson '161 patent. The two tank systems are connected in parallel and each supply fuel to a heat exchanger 32. It should be noted that the system is functionally equivalent if each tank system 80a and 80b has its own heat exchanger and the use lines are teed together after the heat exchangers. Shutoff valve 10 is the final valve in the fuel system before the use device, which may be an engine or fuel cell consuming the fuel contained in the storage tanks.

With continued reference to FIG. 1, a pressure building line 51 branches off the use or vapor delivery line 46, which receives vapor from heat exchanger 32, and feeds vapor back to tank systems 80a and 80b via flow-inducing device 52, line 53 and valves 54a and 54b. The pressure building circuit (including items 51, 52, 53, 54a, and 54b) can be activated when the tank pressures fall below a target pressure. As an example, 100 psig is the target pressure to be maintained in the fuel system. It should be noted that the pressure in tank systems 80a and 80b will be similar due to the fact that the tanks are teed together by their respective use lines immediately before heat exchanger 32. As fuel is withdrawn from tank systems 80a and 80b, the pressure of both systems may decrease gradually. When the pressure falls below 100 psig in this example, flow inducing device 52 is activated by a controller (not shown), which receives pressures from each tank system as input signals. As a result, the flow inducing device will pressurize both tank systems 80a and 80b until the pressure has risen back to the target pressure.

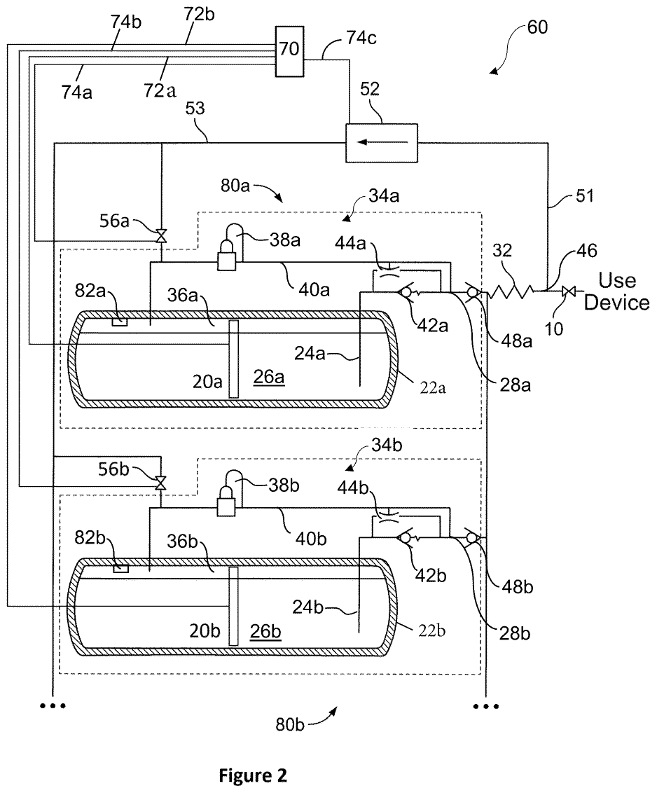

With reference to FIG. 2, an embodiment of the cryogenic liquid delivery and storage system of the disclosure is indicated in general at 60 and includes a control system having controller 70 overlaid on the system of FIG. 1.

As illustrated in FIG. 2, the fuel delivery system includes a first tank system 80a and second tank system 80b, respectively, in which first and second cryogenic tanks 22a, 22b contain a cryogenic fluid such as LNG. While two tank systems 80a and 80b are illustrated, the system 60 may include more than two tank systems. The first and second storage tanks 22a, 22b contain cryogenic liquid 26a and 26b with head spaces 36a and 36b above. First and second liquid lines 24a, 24b are respectively associated with the first and second tank systems 80a, 80b and communicate with the bottoms of first and second storage tanks 22a, 22b where liquid 26a, 26b is contained. Product withdrawal lines 28a, 28b connect liquid lines 24a, 24b to the gas use device such as a vehicle engine.

A heat exchanger or vaporizer 32 is positioned downstream of a junction where fluid streams flowing through first and second withdrawal lines 28a, 28b meet. The heat exchanger 32 warms the cryogenic fluid from tanks 22a, 22b before it is delivered to the use device. Withdrawal lines 28a, 28b include excess flow control valves 48a, 48b, respectively. A withdrawal valve 10 may be taken to represent the throttle of a vehicle where demand for fuel is constantly changing.

The economizer circuits, indicated in general at 34a, 34b, include vapor lines 40a, 40b, respectively, which communicate with head spaces 36a, 36b of tanks 22a, 22b. The vapor lines include economizer regulators 38a, 38b respectively, which are set at a predetermined pressure threshold. When the pressure in any of the multiple tanks 22a, 22b exceeds the set point of regulator 38a, 38b, the vapor in the corresponding head space 36a, 36b may be withdrawn through vapor line 40a, 40b to the use device through withdrawal line 28a or 28b. This lowers the pressure in tank 22a or 22b. However, due to the horizontal nature of LNG vehicle fuel tanks, there is often sufficient hydrostatic pressure to cause liquid 26a or 26b to be withdrawn even when regulator 38a or 38b is open. Therefore, biasing relief valves 42a, 42b are included in liquid lines 24a, 24b to cause economizer circuit 34a or 34b to be the path of least resistance when regulators 38a or 38b is open. A small orifice 44a, 44b is located in parallel with relief valves 42a, 42b respectively to allow back flow to the tanks 22a, 22b during transient periods.

With continued reference to FIG. 2, and as described in greater detail below, the controller 70 has inputs from level measurement devices 20a and 20b as well as pressure input from each tank system via pressure sensors 82a and 82b. The positions of pressure sensors 82a and 82b illustrated in FIG. 2 are non-limiting, and the sensors may provide data to controller 70 wirelessly (as illustrated in FIG. 2) or via wired connections.

Controller 70 has outputs 74a and 74b that control the opening and closing of control valves 56a and 56b, which are in downstream fluid communication with line 53. The controller 70 also has an output 74c that controls the activation of flow inducing device 52. As an example only, flow inducing device 52 may include a compressor.

In a similar example as above with a setpoint of 100 psig, controller 70 will activate flow inducing device 52 when the pressure within either tank 22a or 22b falls below 100 psig. Additionally, if, for example, tank system 80b has a significantly lower fuel quantity (e.g. more than 5% capacity difference) than tank system 80a, controller 70 will only open control valve 56a when activating flow inducing device 52, thereby primarily increasing the pressure in tank system 80a and causing a preferential flow from tank system 80a. When the fuel quantity percentages, and thus tank fill levels, of the multiple tank systems are relatively equal and the system calls for a request to pressure build, controller 70 can open the control valves 56a and 56b to both of the tank systems so that they both increase in pressure.

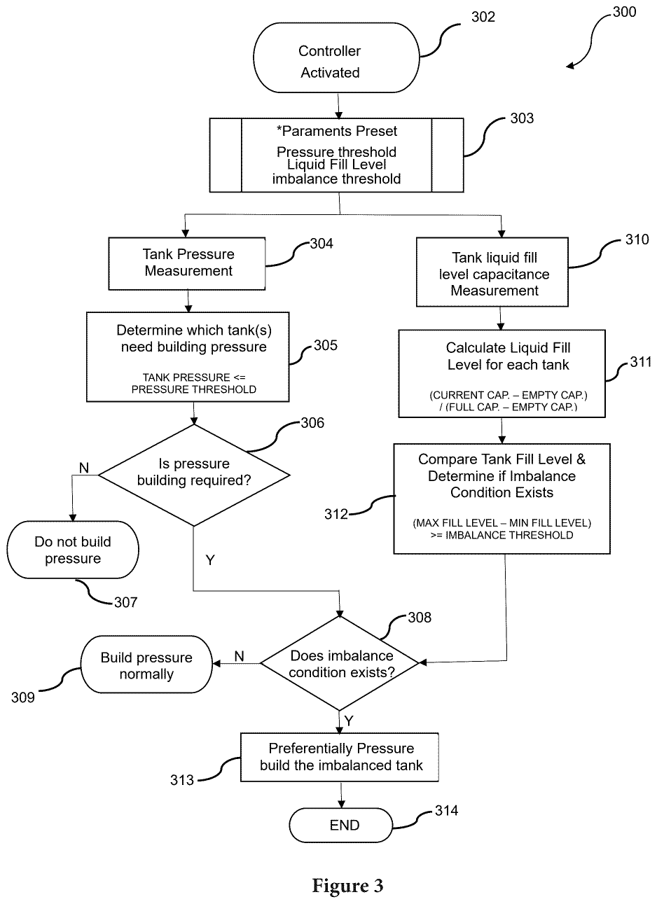

A flow diagram illustrating a method performed by the control system (including controller 70) of FIG. 2 is illustrated in FIG. 3 at 300. As indicated in block 302, the controller (70 of FIG. 2) is initially activated. This may occur, for example, when the vehicle is started or vehicle movement is detected. The pressure sensors (82a and 82b of FIG. 2) optionally may also be activated at this point. As indicated in block 303, the controller accesses the previously stored pressure threshold for the tanks (reflecting required operational pressure of the use device/engine) and the fill level imbalance threshold. The parameters may optionally be set and/or adjusted during operation.

As indicated in blocks 304, 310, the control system may then detect tank pressure and/or fill level in each of tanks 22a, 22b (FIG. 2). The steps of detecting tank pressure and fill level may be simultaneous or sequential.

Following block 304, with reference to block 305, the system determines if any of first tank pressure designating tank pressure of the first tank 22a and/or second tank pressure designating tank pressure of the second tank 22b, as detected by the first and second pressure sensor 82a, 82b respectively, fall below or equal to the predetermined pressure threshold. As indicated by block 306, further processing is then directed based on whether pressure building in either or both tanks is required.

If the system determines that pressure building is not required, indicated by “N” for decision block 306, the flow inducing device 52 will remain deactivated and no pressure building will be performed in the system as shown in block 307.

If the system determines that pressure building in the tanks is required, however, indicated by “Y” for decision block 306, processing passes to block 308.

As exemplified in decision block 308, the system must determine if there exists a fill level imbalance condition in the system to determine further processing. Such determination is achieved by first measuring the fill level in each storage tank in the multiple tanks system as indicated in block 310. In an example, the first level measurement device 20a (FIG. 2) measures first fill level in the first storage tank 22a and the second level measurement device 20b measures second fill level in the second storage tank 22b. In the embodiment illustrated in FIG. 2, the fill level measurement devices 20a, 20b measure tank capacitance in the first and second tanks 22a, 22b to determine the fill level by detecting changes in capacitance as the fill level changes. As shown in block 311, the fill level for each tank is then calculated by the following formula:

$$( Current level capacitance - Empty level capacitance ) / ( Full level - Empty level capacitance )$$

fill level measurement devices known in the art other than those that are capacitance-based may instead be used for fill level measurement devices 20a, 20b

Next, at block 312, controller 70 calculates the difference between the first and second fill level (i.e. the fill level of the first cryogenic liquid 26a in tank 22a and second cryogenic liquid 26b in tank 22b) using the formula (Max fill level-Min fill level).

Controller 70 may then compare the fill level difference against the preset level imbalance threshold as shown in decision block 308. If it is determined that fill level difference between tanks 22a and 22b exceeds the preset level imbalance threshold, indicated by “Y” for decision block 308, processing is passed to block 313 where the system pressurizes the tank(s) with the higher fill level by activating the flow inducing device 52 and opening the pressure control valve (56a or 56b) associated with the higher fill level tank so as to cause a preferential liquid flow from the tank having higher fill level until the fill level amongst all tanks are relatively equal.

If it is determined that the fill level difference between the two tanks does not exceed the preset level imbalance, indicated by “N” for decision block 308, processing passes to block 309 where the flow inducing device 52 is activated and valves 56a and 56b are opened to equally pressurize tanks 22a and 22b until both tanks reach the threshold. The process runs continuously after reaching block 314

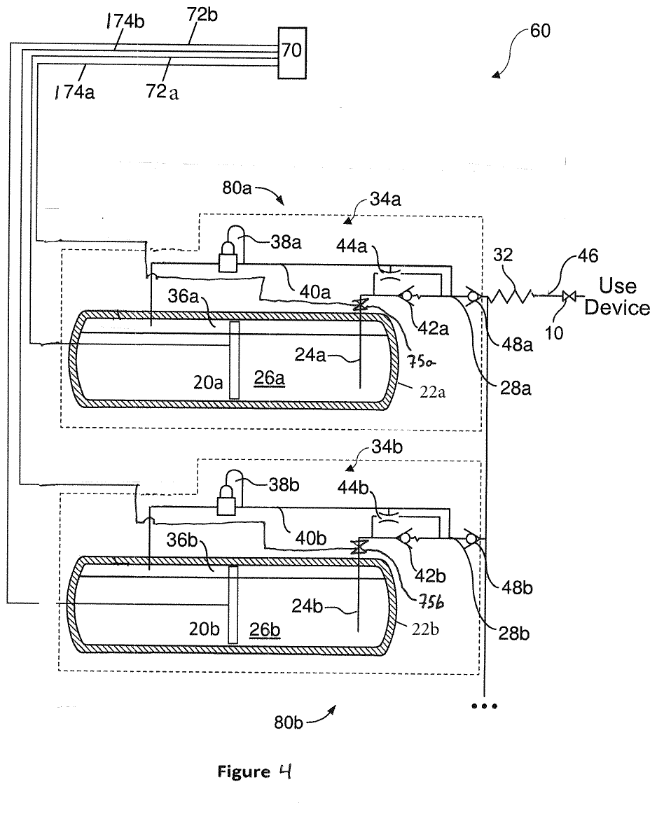

A simplified embodiment of the system of the disclosure is presented in FIG. 4 wherein even withdrawal from the tanks of a multiple tank system is provided by using the controller 70 to operate use control valves 75a and 75b positioned on or in fluid communication with the use lines of each tank.

The system of FIG. 4 includes tank systems 80a and 80b of the type disclosed in the previously-mentioned Gustafson '161 patent. As in the embodiment of FIG. 2, first and second cryogenic tanks 22a, 22b contain a cryogenic fluid such as LNG. While two tank systems 80a and 80b are illustrated, the system 60 may include more than two tank systems. The first and second storage tanks 22a, 22b contain cryogenic liquid 26a and 26b with head spaces 36a and 36b containing vapor above. First and second liquid lines 24a, 24b are respectively associated with the first and second tank systems 80a, 80b and communicate with the bottoms of first and second storage tanks 22a, 22b where liquid 26a, 26b is contained. Product withdrawal lines 28a, 28b connect liquid lines 24a, 24b to the gas use device such as a vehicle engine.

A heat exchanger or vaporizer 32 is positioned downstream of a junction where fluid streams flowing through first and second withdrawal lines 28a, 28b meet. The vaporizer 32 vaporizes the cryogenic liquid from tanks 22a, 22b before it is delivered to the use device. Withdrawal lines 28a, 28b include excess flow control valves 48a, 48b, respectively. Valve 10 may be taken to represent the throttle of a vehicle where demand for fuel is constantly changing.

As in the embodiment of FIG. 2, the economizer circuits, indicated in general at 34a, 34b, include vapor lines 40a, 40b, respectively, which communicate with head spaces 36a, 36b of tanks 22a, 22b. The vapor lines include economizer regulators 38a, 38b respectively, which are set at a predetermined pressure threshold. When the pressure in any of the multiple tanks 22a, 22b exceeds the set point of regulator 38a, 38b, the vapor in the corresponding head space 36a, 36b may be withdrawn through vapor line 40a, 40b to the use device through withdrawal line 28a or 28b. This lowers the pressure in tank 22a or 22b. Biasing relief valves 42a, 42b are included in liquid lines 24a, 24b to cause economizer circuit 34a or 34b to be the path of least resistance when regulators 38a or 38b is open. A small orifice 44a, 44b is located in parallel with relief valves 42a, 42b respectively to allow back flow to the tanks 22a, 22b during transient periods.

In the embodiment of FIG. 4, the controller 70 of the control system has inputs from level measurement devices 20a and 20b. In contrast to the embodiment of FIG. 2, controller 70 has outputs 174a and 174b that control the opening and closing of use control valves 75a and 75b, which are positioned in liquid lines 24a and 24b.

While the simplified control system of FIG. 4 is shown in use with a multiple tank system lacking active tank pressure building, the control system may alternatively be used with multiple tank systems featuring active tank pressure building, such as the tank systems of FIG. 2.

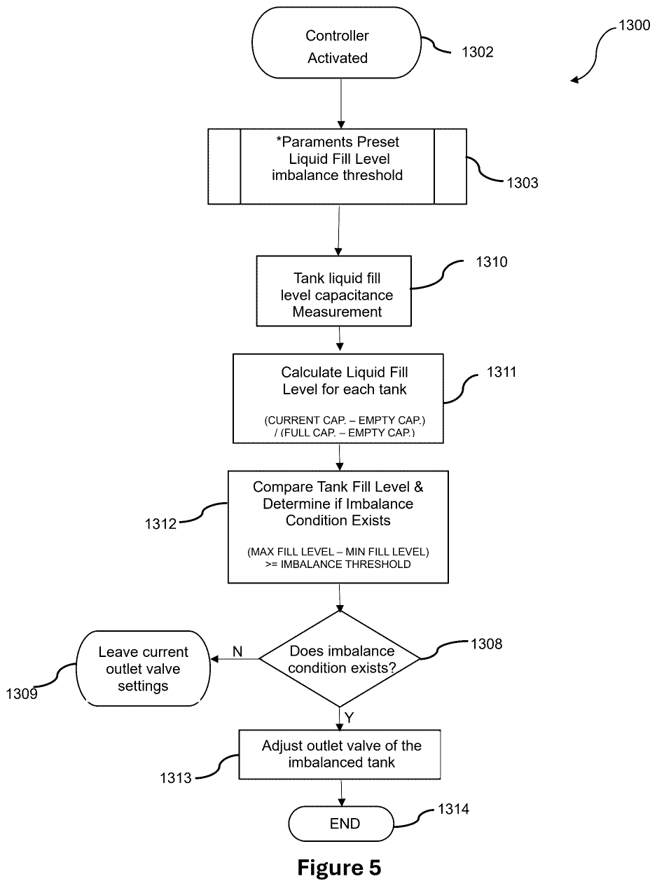

A method of operating the simplified system of FIG. 4 will now be provided with reference to the flow chart indicated in general at 1300 in FIG. 5. As indicated in block 1302, the controller (70 of FIG. 4) is initially activated. This may occur, for example, when the vehicle is started or vehicle movement is detected. As indicated in block 1303, the controller accesses the previously stored fill level imbalance threshold.

As indicated in block 1310, the control system may then detect tank the fill level in each of tanks 22a, 22b (FIG. 4).

In an example, the first level measurement device 20a measures first fill level in the first storage tank 22a and the second level measurement device 20b measures second fill level in the second storage tank 22b. In the embodiment illustrated in FIG. 4, the fill level measurement devices 20a, 20b measure tank capacitance in the first and second tanks 22a, 22b to determine the fill level by detecting changes in capacitance as the fill level changes. As shown in block 1311, the fill level for each tank is then calculated by the following formula:

$$( Current level capacitance - Empty level capacitance ) / ( Full level - Empty level capacitance )$$

Fill level measurement devices known in the art other than those that are capacitance-based may instead be used for fill level measurement devices 20a, 20b

Next, at block 1312, controller 70 of FIG. 4 calculates the difference between the first and second fill level (i.e. the fill level of the first cryogenic liquid 26a in tank 22a and second cryogenic liquid 26b in tank 22b) using the formula (Max fill level-Min fill level).

Controller 70 may then compare the fill level difference against the preset level imbalance threshold as shown in decision block 1308.

If it is determined that the fill level difference between the two tanks 20a and 20b of FIG. 4 does not exceed the preset level imbalance, indicated by “N” for decision block 1308, processing passes to block 1309 where the settings of outlet or use control valves 75a and 75b of FIG. 4 are retained.

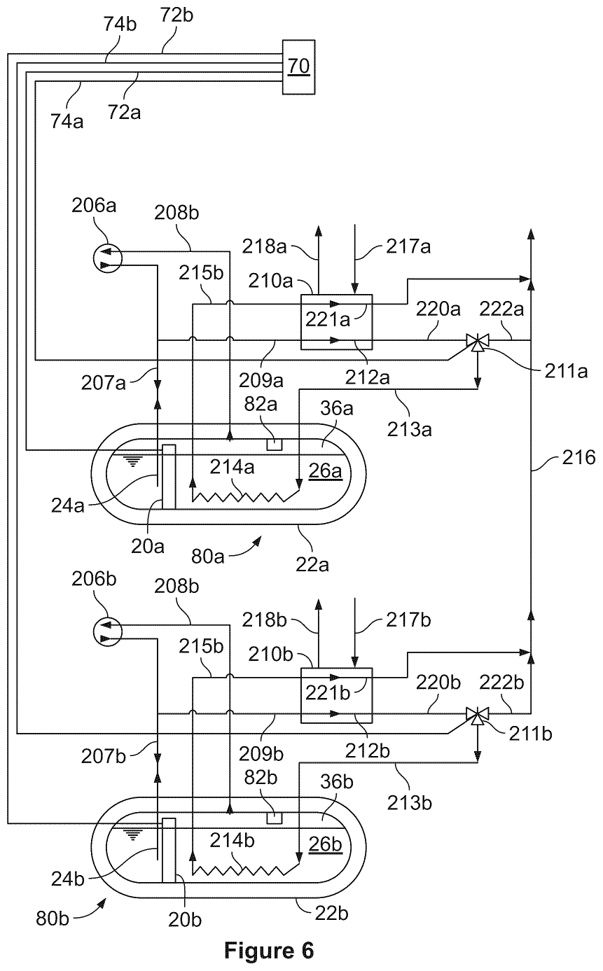

If it is determined at decision block 1308 that fill level difference between tanks 22a and 22b exceeds the preset level imbalance threshold, indicated by “Y” for decision block 1308, processing is passed to block 1313 where the system manipulates outlet control valves 75a and 75b of FIG. 4 so as to cause a preferential liquid flow from the tank having higher fill level until the fill level amongst all tanks are relatively equal. For example, if tank 22a has a higher fill level than tank 22b, valve 75a may be opened further than valve 75b, or valve 75b may be closed further than valve 75a. FIG. 6 depicts an embodiment of the fuel delivery system that uses the tank systems (80a and 80b of FIG. 6) of the French '822 patent. As in previous embodiments, tank systems 80a, 80b include first and second vehicle-mounted storage tanks 22a, 22b where liquid 26a, 26b is contained with head spaces 36a, 36b above. The tanks 22a, 22b are refilled with liquid using filling ports 206a, 206b and liquid lines 207a, 207b along with vapor return lines 209a, 209b.

As in previous embodiments, while two tank systems 80a, 80b are illustrated in FIG. 6, the system of FIG. 6 may alternatively feature more than two tank systems.

Pressure within the tanks 22a and 22b drives liquid 26a, 26b out of the tanks and through first and second liquid lines 207a, 207b and corresponding first and second liquid withdrawal lines 209a, 209b. As explained in the French '822 patent, lines 209a, 209b direct liquid from tanks 22a, 22b to primary heat transfer passages 212a, 212b of vaporizers 210a, 210b. Vaporizers 210a, 210b receive warmed motor cooling water 217a, 217b from the vehicle motor or engine. As a result, the liquid flowing from lines 209a, 209b is heated and vaporized by indirect heat exchange with the warmed motor cooling water in the vaporizers 210a, 210b. The resulting cooled motor cooling water exits the heat exchangers as streams 218a, 218b and is directed back to the vehicle engine.

The vapor streams exiting the vaporizers 210a, 210b flow through lines 220a, 220b to valve systems, such as three-way valves 211a, 211b, and exit the valve systems through first and second primary outlets so as to provide fuel to the vehicle engine through vapor delivery line 216.

The positions of the three-way valves 211a, 211b are controlled by a controller 70 via lines 74a, 74b. During the operation of the vehicle, partial flows of the vapor from lines 220a, 220b is directed from first and second pressure building outlets of the valves 211a, 211b through the lines 213a, 213b to the heat exchangers or evaporation pipes 214a, 214b so that the temperature of liquid 26a, 26b is increased, with portions of liquid 26a, 26b being vaporized so as to increase the pressures within tanks 22a, 22b. Fluid exiting evaporation pipes 214a, 214b flows through lines 215a, 215b to secondary heat transfer passages 221a, 221b of vaporizers 210a, 210b for reheating with the resulting vapor streams joining vapor delivery line 216.

While three-way valves 211a, 211b are illustrated as the valve systems, they could be replaced with alternative valve systems known in the art. For example, a first junction at the intersection of lines 220a, 222a and 213a and at a second junction at an intersection at the intersection of lines 220b, 222b and 213b with individual two-way valves on lines 213a and 213b and individual two-way valves on lines 222a and 222b with the controller 70 controlling each two-way valve.

As in the embodiments of FIGS. 2 and 4, the tanks 22a, 22b of the system of FIG. 6 are provided with fill level measurement devices 20a, 20b which communicate with controller 70 via lines 72a and 72b. In addition, the tanks 20a, 20b are provided with first and second pressure sensors 82a, 82b that provide a pressure input to controller 70 from each tank system. The positions of pressure sensors 82a and 82b illustrated in FIG. 6 are non-limiting, and the sensors may provide data to controller 70 wirelessly (as illustrated in FIG. 6) or via wired connections.

As a result, the method of FIG. 3 may be used for operating the cryogenic fluid storage and delivery system of FIG. 6, where pressure building within tanks 22a and 22b may be controlled by adjusting the amount of fluid directed through lines 213a, 213b via adjustment of valves 211a, 211b.

The invention has been described with reference to various specific and preferred embodiments and techniques. Nevertheless, it is understood that many variations and modifications may be made while remaining within the spirit and scope of the invention.

What is claimed is:

1. A cryogenic fluid delivery system comprising:
a. a first storage tank (22a) configured to contain a first supply of cryogenic liquid (26a), said first storage tank (22a) including a first head space (36a) configured to contain a first vapor above the first supply of cryogenic liquid (26a) stored in the first storage tank (22a);
b. a first liquid withdrawal line (28a) configured to communicate with the first supply of cryogenic liquid (26a);
c. a vapor delivery line (46);
d. a vaporizer (32) having an inlet in communication with the first liquid withdrawal line (28a) and an outlet in communication with the vapor delivery line (46);
e. a pressure building circuit in communication with the vapor delivery line (46) and the first head space (36a) of the first storage tank (22a) and including a flow inducing device (52);
f. a first pressure control valve (56a) in communication with an outlet of the flow inducing device (52) and the first head space (36a); and
g. a second storage tank (22b) configured to contain a second supply of cryogenic liquid (26b), said second storage tank (22b) including a second head space (36b) configured to contain a second vapor above the second supply of cryogenic liquid (26b) stored in the second storage tank (22b);
h. a second liquid withdrawal line (28b) having an inlet configured to communicate with the second supply of cryogenic liquid (26b);
i. said second liquid withdrawal line (28b) having an outlet in fluid communication with the vapor delivery line (46);
j. a second pressure control valve (56b) in communication with the outlet of the flow inducing device (52) and the second head space (36b);
k. a first fill level measurement device (20a) configured to measure a first fill level in the first storage tank (22a) and a second fill level measurement device (20b) configured to measure a second fill level in the second storage tank (22b);
l. a first pressure sensor configured to detect a first pressure of the first head space (36a) and a second pressure sensor configured to detect a second pressure of the second head space (36b);
m. a controller configured to communicate with the first and second fill level measurement devices, the first and second pressure sensors, the flow inducing device (52), the first pressure control valve (56a) and the second pressure control valve (56b).

2. The cryogenic fluid delivery system according to claim 1 wherein the first and second fill level measurement devices are respectively positioned within the first and second storage tanks.

3. The cryogenic fluid delivery system according claim 1 wherein the controller (70) is further configured to calculate fill level difference between the first and second fill levels; and wherein the controller (70) is further configured to control the pressure building circuit in response to the fill level difference falling below a preset imbalance threshold.

4. The cryogenic fluid delivery system according to claim 3 wherein the controller (70) is configured to control the pressure building circuit comprising:
activating the flow inducing device (52) and opening the first pressure control valve (56a) to pressurize the first storage tank (22a) when the first fill level is more than the second fill level.

5. The cryogenic fluid delivery system according to claim 1 wherein the controller (70) is configured to control the pressure building circuit comprising:
activating the flow inducing device (52) and opening the second pressure control valve (56b) to pressurize the second storage tank (22b) when the first fill level is less than the second fill level.

6. The cryogenic fluid delivery system according to claim 1 wherein the pressure building circuit includes an inlet line (51) in communication with the vapor delivery line (46) and an inlet of the flow inducing device (52) and an outlet line (53) in communication with the outlet of the flow inducing device (52); wherein the outlet line (53) is in communication with the first and second head space (36a, 36b) in parallel; wherein the controller (70) is further configured to control the pressure building circuit by returning the vapor to the first head space (36a) if the pressure in the first storage tank (22a) falls below a predetermined pressure threshold and the pressure in the second storage tank (22b) is at the predetermined pressure threshold, until the pressure in the first storage tank (22a) reaches the predetermined pressure threshold.

7. The cryogenic fluid delivery system according to claim 1 wherein the pressure building circuit includes an inlet line (51) in communication with the vapor delivery line (46) and an inlet of the flow inducing device (52) and an outlet line (53) in communication with the outlet of the flow inducing device (52); wherein the outlet line (53) is in communication with the first and second head space (36a, 36b) in parallel; wherein the controller (70) is further configured to control the pressure building circuit (55) by returning the vapor to the second head space (36b) if the pressure in the second storage tank (22b) falls below the predetermined pressure threshold and the pressure in the first storage tank (22a) is at the predetermined pressure threshold, until the pressure in the second storage tank (22b) reaches the predetermined pressure threshold.

8. The cryogenic fluid delivery system according to claim 1 wherein the pressure building circuit includes an inlet line (51) in communication with the vapor delivery line (46) and an inlet of the flow inducing device (52) and an outlet line (53) in communication with the outlet of the flow inducing device (52); wherein the outlet line (53) configured in communication with the first and second head space (36a, 36b) in parallel; wherein the controller (70) is further configured to control the pressure building circuit (55) by returning the vapor to the first and second head space (36a, 36b) if the pressure in the first and second storage tanks (22a, 22b) fall below the predetermined pressure threshold until the pressure reaches the predetermined pressure threshold.

9. The cryogenic fluid delivery system according to claim 1, wherein the controller (70) is configured to control the pressure building circuit by activating the flow inducing device (52) and opening the first pressure control valve (56a) to pressurize the first storage tank (22a).

10. The cryogenic fluid delivery system according to claim 1, wherein the controller (70) is configured to control the pressure building circuit (55) by activating the flow inducing device (52) and opening the second pressure control valve (56b) to pressurize the second storage tank (22b).

11. The cryogenic fluid delivery system according to claim 1, wherein the controller (70) configured to control the pressure building circuit (55) by activating the flow inducing device (52) and opening the first and second pressure control valves (56a, 56b) to pressurize the first and second storage tanks (22a, 22b).

12. The cryogenic fluid delivery system according to claim 1, wherein the controller (70) comprising at least one input port configured to receive input data and at least one output port configured to transmit output data; wherein the system further comprising the first level measurement device (20a) connected to a first input port (72a) of the at least one input port of the controller (70) and configured to measure the first fill level of the first supply of cryogenic liquid (26a) in the first storage tank (22a);
the second level measurement device (20b) connected to a second input port (72b) of the at least one input port of the controller (70) and configured to measure second fill level of the second supply of cryogenic liquid (26b) in the second storage tank (22b); and
the first pressure control valve (56a) connected to a first output port (74a) of the at least one output port of the controller (70) and controlled by the controller (70) to permit the product vapor to travel through the first pressure control valve (56a) to the first head space (36a);
the second pressure control valve (56b) connected to a second output port (74b) of the at least one output port of the controller (70) and controlled by the controller (70) to permit the product vapor to travel through the second pressure control valve (56b) to the second head space (36b); and
the flow inducing device 52 connected to a third output port (74c) of the at least one output port of the controller (70).

13. The cryogenic fluid delivery system of claim 1 wherein the flow inducing device (52) includes a compressor.

14. The cryogenic fluid delivery system of claim 1 further wherein the controller (70) activates the flow inducing device (52) when the first pressure of the first head space (36a) and/or the second pressure of the second head space (36b) detected by the first and/or second pressure sensors (82a, 82b) drops below a predetermined pressure threshold.

15. The cryogenic fluid delivery system of claim 1 further comprising a withdrawal valve (10) positioned within the vapor delivery line and wherein the pressure building circuit has an inlet in vapor communication with the vapor delivery line between the withdrawal valve and the outlet of the vaporizer so that vapor produced by the vaporizer may be delivered to the pressure building circuit both when the withdrawal valve is open and closed.

16. The cryogenic fluid delivery system of claim 1 wherein the first and second fill level measurement devices use capacitance to determine fill levels within the first and second storage tanks.

17. The cryogenic fluid delivery system of claim 1 wherein the first storage tank is provided with a first economizer circuit in fluid communication with first head space and the vapor delivery line and the second storage tank is provided with a second economizer circuit in fluid communication with the second head space and the vapor delivery line.

18. A method of operating a cryogenic fluid delivery system having a flow inducing device, a first storage tank (22a) containing a first supply of cryogenic liquid (26a) and a first head space (36a) containing a first vapor above the first supply of cryogenic liquid (26a) and a second storage tank (22b) containing a second supply of cryogenic liquid (26b) and a second head space (36b) containing a second vapor above the second supply of cryogenic liquid (26b) stored in the second storage tank (22b), the method comprising the steps of:
a. detecting a first pressure in the first storage tank (22a) and a second pressure in the second storage tank (22b);
b. determining if either the first or the second pressure falls below a predetermined pressure threshold;
c. measuring a first fill level in the first storage tank (22a) and a second fill level in the second storage tank (22b);
d. calculating a fill level difference between the first and second fill levels;
e. determining if the fill level difference exceeds a preset imbalance threshold;
f. activating the flow inducing device (52) if either the first or the second pressure falls below the predetermined pressure threshold to:
(i) pressurize the first storage tank (22a) if the first fill level is more than the second fill level and the fill level difference exceeds the preset imbalance threshold; or
(ii) pressurize the second storage tank (22a) if the second fill level is more than the first fill level and the fill level difference exceeds the preset imbalance threshold; or
(iii) pressurize both the first and second storage tanks if the fill level difference does not exceed the preset imbalance threshold.

19. A cryogenic fluid delivery system comprising:
a. a first storage tank (22a) configured to contain a first supply of cryogenic liquid (26a), said first storage tank (22a) including a first head space (36a) configured to contain a first vapor above the first supply of cryogenic liquid (26a) stored in the first storage tank (22a);
b. a first liquid withdrawal line (28a) configured to communicate with the first supply of cryogenic liquid (26a);
c. a vapor delivery line (46);
d. a vaporizer (32) having an inlet in communication with the first liquid withdrawal line (28a) and an outlet in communication with the vapor delivery line (46);
e. a second storage tank (22b) configured to contain a second supply of cryogenic liquid (26b), said second storage tank (22b) including a second head space (36b) configured to contain a second vapor above the second supply of cryogenic liquid (26b) stored in the second storage tank (22b);
f. a second liquid withdrawal line (28b) having an inlet configured to communicate with the second supply of cryogenic liquid (26b);
g. said second liquid withdrawal line (28b) having an outlet in fluid communication with the vapor delivery line (46);
h. a first fill level measurement device (20a) configured to measure a first fill level in the first storage tank (22a) and a second fill level measurement device (20b) configured to measure a second fill level in the second storage tank (22b);
i. a first outlet control valve (75a) in fluid communication with the first liquid withdrawal line (28a);
j. a second outlet control valve (75b) in fluid communication with the second liquid withdrawal line (28b);
k. a controller configured to communicate with the first and second fill level measurement devices, the first outlet control valve (75a) and the outlet control valve (75b).

20. A method of operating a cryogenic fluid delivery system having a first storage tank (22a) containing a first supply of cryogenic liquid (26a) and a first head space (36a) containing a first vapor above the first supply of cryogenic liquid (26a), a second storage tank (22b) containing a second supply of cryogenic liquid (26b) and a second head space (36b) containing a second vapor above the second supply of cryogenic liquid (26b) stored in the second storage tank (22b), a first liquid withdrawal line having a first outlet control valve (75a) in fluid communication with the first supply of cryogenic liquid and a second liquid withdrawal line having a second outlet control valve (75b) in fluid communication with the second supply of cryogenic liquid, the method comprising the steps of:
a. measuring a first fill level in the first storage tank (22a) and a second fill level in the second storage tank (22b);
b. calculating a fill level difference between the first and second fill levels;
c. determining if the fill level difference exceeds a preset imbalance threshold;
d. adjusting the first outlet control valve and/or the second outlet control valve to:
(i) increase a flow of cryogenic liquid out of the first storage tank (22a) if the first fill level is more than the second fill level and the fill level difference exceeds the preset imbalance threshold; or
(ii) increase the flow of cryogenic liquid out of the second storage tank (22a) if the second fill level is more than the first fill level and the fill level difference exceeds the preset imbalance threshold.

21. A cryogenic fluid delivery system comprising:
a. a first storage tank (22a) configured to contain a first supply of cryogenic liquid (26a), said first storage tank (22a) including a first head space (36a) configured to contain a first vapor above the first supply of cryogenic liquid (26a) stored in the first storage tank (22a);
b. a first liquid withdrawal line (209a) configured to communicate with the first supply of cryogenic liquid (26a);
c. a vapor delivery line (216);
d. a first vaporizer (210a) having a first primary heat transfer passage (212a) with an inlet in communication with the first liquid withdrawal line (209a) and an outlet;
e. a first valve system (211a) having an inlet configured to receive vapor from the outlet of the first primary heat transfer passage (212a) of the first vaporizer (210a), a primary outlet in fluid communication with the vapor delivery line (216) and a pressure building outlet;
f. a first heat exchanger (214a) configured to be submerged in the first supply of cryogenic liquid (26a) in the first storage tank (22a) and having an inlet in fluid communication with the pressure building outlet of the first valve system and an outlet;
g. said first vaporizer (210a) having a first secondary heat transfer passage (221a) configured to receive fluid from the outlet of the first heat exchanger (214a) and to direct warmed fluid to the vapor delivery line (216);
h. a second storage tank (22b) configured to contain a second supply of cryogenic liquid (26b), said second storage tank (22b) including a second head space (36b) configured to contain a second vapor above the second supply of cryogenic liquid (26b) stored in the second storage tank (22b);
i. a second liquid withdrawal line (209b) configured to communicate with the second supply of cryogenic liquid (26b);
j. a second vaporizer (210b) having a second primary heat transfer passage (212b) with an inlet in communication with the second liquid withdrawal line (209b) and an outlet;
k. a second valve system (211b) having an inlet configured to receive vapor from the outlet of the second primary heat transfer passage (212b) of the second vaporizer (210b), a primary outlet in fluid communication with the vapor delivery line (216) and a pressure building outlet;
l. a second heat exchanger (214b) configured to be submerged in the second supply of cryogenic liquid (26b) in the second storage tank (22b) and having an inlet in fluid communication with the pressure building outlet of the second valve system and an outlet;
m. said secondary vaporizer (210b) having a second secondary heat transfer passage (221b) configured to receive fluid from the outlet of the second heat exchanger (214b) and to direct warmed fluid to the vapor delivery line (216);
n. a first fill level measurement device (20a) configured to measure a first fill level in the first storage tank (22a) and a second fill level measurement device (20b) configured to measure a second fill level in the second storage tank (22b);
o. a first pressure sensor configured to detect a first pressure of the first head space (36a) and a second pressure sensor configured to detect a second pressure of the second head space (36b);
p. a controller (70) configured to communicate with the first and second fill level measurement devices, the first and second pressure sensors and the first and second valve systems.

22. The system of claim 21 wherein the first valve system includes a first three-way valve and the second valve system includes a second three-way valve.

23. A method of operating a cryogenic fluid delivery system having a first storage tank (22a) containing a first supply of cryogenic liquid (26a) and a first head space (36a) containing a first vapor above the first supply of cryogenic liquid (26a) and a second storage tank (22b) containing a second supply of cryogenic liquid (26b) and a second head space (36b) containing a second vapor above the second supply of cryogenic liquid (26b) stored in the second storage tank (22b), a first heat exchanger (214a) submerged in the first supply of cryogenic liquid, a second heat exchanger (214b) submerged in the second supply of cryogenic liquid, a first valve system which may be adjusted to direct cryogenic liquid from the first storage tank (22a) to the first heat exchanger (214a) and a second valve system which may be adjusted to direct cryogenic liquid from the second storage tank (22b) to the second heat exchanger (214b), the method comprising the steps of:
a. detecting a first pressure in the first storage tank (22a) and a second pressure in the second storage tank (22b);
b. determining if either the first or the second pressure falls below a predetermined pressure threshold;
c. measuring a first fill level in the first storage tank (22a) and a second fill level in the second storage tank (22b);
d. calculating a fill level difference between the first and second fill levels;
e. determining if the fill level difference exceeds a preset imbalance threshold;
f. adjusting the first valve system and/or the second valve system if either the first or the second pressure falls below the predetermined pressure threshold to:
(i) pressurize the first storage tank (22a) if the first fill level is more than the second fill level and the fill level difference exceeds the preset imbalance threshold; or
(ii) pressurize the second storage tank (22a) if the second fill level is more than the first fill level and the fill level difference exceeds the preset imbalance threshold; or
(iii) pressurize both the first and second storage tanks if the fill level difference does not exceed the preset imbalance threshold.
